(19) United States
(12) Patent Application Publication
(10) Pub. No.: US 2026/0119195 A1
(43) Pub. Date: Apr. 30, 2026

(54) Server Booting Method and Apparatus, Storage Medium, and Electronic Device

(71) Applicant: SUZHOU METABRAIN INTELLIGENT TECHNOLOGY CO., LTD., Suzhou, Jiangsu (CN)

(72) Inventors: Xiuqiang SUN, Suzhou, Jiangsu (CN); Baojun LIU, Suzhou, Jiangsu (CN); Lu ZHANG, Suzhou, Jiangsu (CN)

(73) Assignee: SUZHOU METABRAIN INTELLIGENT TECHNOLOGY CO., LTD., Suzhou, Jiangsu (CN)

(21) Appl. No.: 19/166,623

(22) PCT Filed: Sep. 30, 2024
(86) PCT No.: PCT/CN2024/122612

§ 371 Date: Sep. 18, 2025

(30) Foreign Application Priority Data
Feb. 27, 2024 (CN) 202410216549.8

(51) Int. Cl. G06F 9/4401

(52) U.S. Cl. CPC G06F 9/4416

(57) ABSTRACT

A server booting method and apparatus, a storage medium, and an electronic device are provided. The server booting method includes: in response to determining that execution has proceeded to a peripheral component interconnect enumeration stage, detecting in-place information of network device interfaces in a network device interface group; disabling preboot execution environment control functions of a plurality of reference network devices correspondingly connected to a plurality of reference network device interfaces in the network device interface group; screening a target network device from the plurality of reference network devices according to reference device types of the reference network devices correspondingly connected to the plurality of reference network device interfaces; and enabling the preboot execution environment control function of the target network device.

### CROSS-REFERENCE TO RELATED APPLICATION

The present disclosure claims the priority of Chinese Patent Application 202410216549.8, filed before the China National Intellectual Property Administration (CNIPA) on Feb. 27, 2024, and entitled “Server Booting Method and Apparatus, Storage Medium, and Electronic Device”, the entire contents of which are herein incorporated by reference.

### TECHNICAL FIELD

Embodiments of the present disclosure relate to the field of computers, and in particular, to a server booting method and apparatus, a storage medium, and an electronic device.

### BACKGROUND

In the related art, a Preboot eXecution Environment (PXE) function may usually be enabled by a network interface to install an operating system in a server. However, the server usually includes a plurality of network interfaces, and the plurality of network interfaces may be connected with a plurality of network interface cards at the same moment. By default, the PXE function of the network interfaces of the server is enabled in an order the network interfaces are identified during the enablement, regardless of the type of the network interface card currently connected to the network interface, and the network interface card of the first identified network interface is directly used to execute the PXE function to install the operating system in the server.

In this case, since the operating systems installed in the server by the network interface cards of different network interfaces by means of executing the PXE function may be different, and the actually linked network interface at present may not be the first identified network interface or may be a certain specific network interface, such as the network interface of a smart network interface card, the operating system installed in the server by the network interface card of the first identified network interface by means of executing the PXE function may not be the system required at present, or a pre-installed system may not be located as expected, resulting in incompatibility with other network interface cards. For example, the network interface card of the first identified network interface is an Open Compute Project (OCP) network interface card, and the system installed by enabling the PXE function of the OCP network interface card cannot support the simultaneous use of the intelligent network card on the server.

### SUMMARY

According to some embodiments of the present disclosure, a server booting method is provided, wherein the server booting method is applied to a basic input output system installed in a server, a network device interface group is deployed on the server, network device interfaces in the network device interface group are used for connecting network devices, the network devices have preboot execution environment control functions, and the server booting method includes:
in response to determining that execution has proceeded to a peripheral component interconnect enumeration stage, detecting in-place information of the network device interfaces in the network device interface group, wherein the in-place information is used for indicating whether corresponding network device interfaces are connected with the network devices;
disabling the preboot execution environment control functions of a plurality of reference network devices correspondingly connected to a plurality of reference network device interfaces in the network device interface group, wherein the reference network device interfaces are network device interfaces of which the in-place information is used for indicating that the reference network devices have been connected;
screening a target network device from the plurality of reference network devices according to reference device types of the reference network devices correspondingly connected to the plurality of reference network device interfaces, wherein the target network device is a network device of which a target booting priority corresponding to a target device type to which the network device belongs is highest among the plurality of reference network devices, device types of the network devices are used for indicating device versions of the network devices, the preboot execution environment control functions are downward compatible from high to low device versions, and each device type is set with a corresponding booting priority that is proportional to the device version indicated by the device type; and
enabling the preboot execution environment control function of the target network device.

In some embodiments, in response to determining that the network devices are network interface card devices, screening the target network device from the plurality of reference network devices according to the reference device types of the reference network devices correspondingly connected to the plurality of reference network device interfaces includes:
identifying the device type of each reference network device among the plurality of reference network devices until all of the plurality of reference network devices are identified, so as to obtain a plurality of reference device types;
in response to determining that the plurality of reference device types include a smart network interface card type, determining a network interface card device of the smart network interface card type among the plurality of reference device types as the target network device having the highest booting priority;
in response to determining that the plurality of reference device types do not include the smart network interface card type, but include an open compute project network interface card type, determining a network interface card device of the open compute project network interface card type among the plurality of reference device types as the target network device having the highest booting priority; and
in response to determining that the plurality of reference device types do not include the smart network interface card type and the open compute project network interface card type, but include a peripheral component interconnect network interface card type, determining a network interface card device of the peripheral component interconnect network interface card type among the plurality of reference device types as the target network device having the highest booting priority.

In some embodiments, in response to determining that the network devices are network interface card devices, screening the target network device from the plurality of reference network devices according to the reference device types of the reference network devices correspondingly connected to the plurality of reference network device interfaces includes:
extracting a current candidate network device to be identified from the plurality of reference network devices;
identifying the device type of the candidate network device to obtain a candidate device type, wherein the reference device types include the candidate device type;
determining whether the candidate device type is a smart network interface card type;
in response to determining that the candidate device type is the smart network interface card type, ending the identification in advance, and determining the candidate network device as the target network device having the highest booting priority;
in response to determining that the candidate device type is not the smart network interface card type, continuing to extract a next reference network device that has not yet been identified from the plurality of reference network devices as the current candidate network device to be identified, until there is no reference network device that has not yet been identified among the plurality of reference network devices, and ending the identification to obtain a plurality of candidate device types;
in response to determining that the plurality of candidate device types include an open compute project network interface card type, determining a network interface card device of the open compute project network interface card type among the plurality of reference network devices as the target network device having the highest booting priority; and
in response to determining that the plurality of candidate device types do not include the open compute project network interface card type, but include a peripheral component interconnect network interface card type, determining a network interface card device of the peripheral component interconnect network interface card type among the plurality of reference network devices as the target network device having the highest booting priority.

In some embodiments, disabling the preboot execution environment control functions of the reference network devices correspondingly connected to the plurality of reference network device interfaces in the network device interface group includes:
updating network interface parameters corresponding to the plurality of reference network device interfaces to a first network interface parameter, wherein the first network interface parameter is used for instructing the corresponding reference network device interfaces to disable the preboot execution environment control functions of the reference network devices connected to the corresponding reference network device interfaces.

In some embodiments, enabling the preboot execution environment control function of the target network device includes:
locating, from the plurality of reference network device interfaces, a target network device interface corresponding to the target network device; and
updating a network interface parameter of the target network device interface to a second network interface parameter, wherein the second network interface parameter is used for instructing the target network device interface to enable the preboot execution environment control function of the connected target network device.

In some embodiments, the server booting method may further include: after disabling the preboot execution environment control functions of the reference network devices correspondingly connected to the plurality of reference network device interfaces in the network device interface group,
creating a control option for each reference network device interface among the plurality of reference network device interfaces on a basic input output system interface of the basic input output system, wherein each control option is used for controlling the corresponding reference network device interface to enable or disable the preboot execution environment control function of the reference network device connected to the corresponding reference network device interface.

In some embodiments, the server booting method may further include: after creating the control option for each reference network device interface among the plurality of reference network device interfaces on the basic input output system interface of the basic input output system,
detecting whether there is a control option which has been subjected to an adjustment operation; and
in response to detecting that there is the control option which has been subjected to the adjustment operation, enabling the preboot execution environment control function of the reference network device corresponding to the control option which has been subjected to the adjustment operation, and controlling other currently enabled preboot execution environment control functions in the server to be disabled.

In some embodiments, the server booting method may further include: after screening the target network device from the plurality of reference network devices according to the reference device types of the reference network devices correspondingly connected to the plurality of reference network device interfaces,
detecting whether there is a control option which has been subjected to an adjustment operation;
in response to detecting that there is the control option which has been subjected to the adjustment operation, acquiring, from the plurality of reference network device interfaces, a candidate network device interface corresponding to the control option which has been subjected to the adjustment operation, and generating a target confirmation instruction, wherein the target confirmation instruction is used for requesting a target account to determine, from an alternative network device connected to the candidate network device interface and the target network device, a network device whose preboot execution environment control function is allowed to be enabled; and
receiving target confirmation information returned by the target account, and controlling the preboot execution environment control function of the corresponding network device to be enabled according to the target confirmation information, wherein the target confirmation information is used for indicating the network device whose preboot execution environment control function is allowed to be enabled.

In some embodiments, screening the target network device from the plurality of reference network devices according to the reference device types of the reference network devices correspondingly connected to the plurality of reference network device interfaces includes:
detecting device types of the reference network devices correspondingly connected to the plurality of reference network device interfaces to obtain the reference device types; and
screening the target network device from the plurality of reference network devices according to the detected reference device types.

In some embodiments, detecting the device types of the reference network devices correspondingly connected to the plurality of reference network device interfaces to obtain the reference device types includes:
reading device identification messages from the reference network devices correspondingly connected to the plurality of reference network device interfaces, wherein the device identification messages are used for indicating the device types of the corresponding reference network devices; and
parsing the device identification messages to obtain the reference device types of the reference network devices.

In some embodiments, detecting the device types of the reference network devices correspondingly connected to the plurality of reference network device interfaces to obtain the reference device types may further include:
sending a target request instruction to the reference network devices correspondingly connected to the plurality of reference network device interfaces, wherein the target request instruction is used for requesting the reference network devices correspondingly connected to the plurality of reference network device interfaces to send device identification messages to the basic input output system, and the device identification messages are used for indicating the device types of the corresponding reference network devices; and
receiving the device identification messages sent by the reference network devices correspondingly connected to the plurality of reference network device interfaces, and parsing the device identification messages to obtain the reference device types of the reference network devices.

In some embodiments, detecting the device types of the reference network devices correspondingly connected to the plurality of reference network device interfaces to obtain the reference device types includes:
sequentially detecting, according to a target detection sequence, the device types of the reference network devices correspondingly connected to the plurality of reference network device interfaces to obtain the reference device types, wherein the target detection sequence records a detection sequence of the plurality of reference network device interfaces, in the target detection sequence, the higher a rank of the reference network device interface is, the higher a reference device version of the network device allowed to be connected to the reference network device interface is, and the reference device version is the highest device version of the network device allowed to be connected to the corresponding reference network device interface.

In some embodiments, the server booting method may further include: in response to determining that the network devices are network interface card devices, before sequentially detecting, according to the target detection sequence, the device types of the reference network devices correspondingly connected to the plurality of reference network device interfaces to obtain the reference device types,
in response to determining that the plurality of reference network device interfaces include a first network device interface, a second network device interface and a third network device interface, constructing a first detection sequence in an order of the first network device interface, the second network device interface and the third network device interface, wherein the target detection sequence includes the first detection sequence;
in response to determining that the plurality of reference network device interfaces include the first network device interface and the third network device interface, constructing a second detection sequence in an order of the first network device interface and the third network device interface, wherein the target detection sequence includes the second detection sequence; or
in response to determining that the plurality of reference network device interfaces include the second network device interface and the third network device interface, constructing a third detection sequence in an order of the second network device interface and the third network device interface, wherein the target detection sequence includes the third detection sequence, wherein
the network device of the highest device version allowed to be connected to the first network device interface is a network interface card device of a smart network interface card type, the network device of the highest device version allowed to be connected to the second network device interface is a network interface card device of an open compute project network interface card type, the network device of the highest device version allowed to be connected to the third network device interface is a network interface card device of a peripheral component interconnect network interface card type, the device version of the network interface card device indicated by the smart network interface card type is higher than the device version of the network interface card device indicated by the open compute project network interface card type, and the device version of the network interface card device indicated by the open compute project network interface card type is higher than the device version of the network interface card device indicated by the peripheral component interconnect network interface card type.

In some embodiments, updating the network interface parameters corresponding to the plurality of reference network device interfaces to the first network interface parameter includes:
sending, by the basic input output system, a first update instruction carrying the first network interface parameter to the plurality of reference network device interfaces; and
in response to the first update instruction, updating the network interface parameters corresponding to the plurality of reference network device interfaces to the first network interface parameter.

In some embodiments, reading the device identification messages from the reference network devices correspondingly connected to the plurality of reference network device interfaces includes:
reading, by the basic input output system, the device identification messages from the reference network devices correspondingly connected to the plurality of reference network device interfaces.

In some embodiments, in response to determining that the network devices are network interface card devices, screening the target network device from the plurality of reference network devices according to the reference device types of the reference network devices correspondingly connected to the plurality of reference network device interfaces includes:
identifying the reference device types of the plurality of reference network devices to obtain all reference device types, and determining the target network device from all the reference device types.

According to some other embodiments of the embodiments of the present disclosure, a server booting apparatus is further provided, which is applied to a basic input output system installed in a server, wherein a network device interface group is deployed on the server, network device interfaces in the network device interface group are used for connecting network devices, the network devices have preboot execution environment control functions, and the server booting apparatus includes:
a first detection module, configured to: in response to determining that execution has proceeded to a peripheral component interconnect enumeration stage, detect in-place information of the network device interfaces in the network device interface group, wherein the in-place information is used for indicating whether corresponding network device interfaces connected with the network devices;
a disabling module, configured to disable the preboot execution environment control functions of a plurality of reference network devices correspondingly connected to a plurality of reference network device interfaces in the network device interface group, wherein the reference network device interfaces are network device interfaces of which the in-place information is used for indicating that the reference network devices have been connected;
a screening module, configured to screen a target network device from the plurality of reference network devices according to reference device types of the reference network devices correspondingly connected to the plurality of reference network device interfaces, wherein the target network device is a network device of which a target booting priority corresponding to a target device type to which the network device belongs is highest among the plurality of reference network devices, device types of the network devices are used for indicating device versions of the network devices, the preboot execution environment control functions are downward compatible from high to low device versions, and each device type is set with a corresponding booting priority that is proportional to the device version indicated by the device type; and
an enabling module, configured to enable the preboot execution environment control function of the target network device.

According to some other embodiments of the present disclosure, a computer program product is further provided, storing a computer-readable instruction, wherein the computer-readable instruction implements operations in any of the above method embodiments when executed by one or more processors.

According to some other embodiments of the present disclosure, a non-transitory computer-readable storage medium is further provided, wherein the non-transitory computer-readable storage medium stores a computer-readable instruction, and the computer-readable instruction implements operations in any of the above method embodiments when executed by one or more processors.

According to some other embodiments of the present disclosure, an electronic device is further provided, including: one or more processors; and a memory associated with the one or more processors, wherein the memory is configured to store a computer-readable instruction, and the computer-readable instruction implements operations in any of the above method embodiments when executed by the one or more processors.

In the embodiments of the present disclosure, a server booting method is provided, which is applied to the basic input output system installed in the server, the network device interface group is deployed on the server, the network device interfaces in the network device interface group are used for connecting the network devices, the network devices have the preboot execution environment control functions, when execution of a booting process of the server has proceeded to the peripheral component interconnect enumeration stage, the in-place information of the network device interfaces in the network device interface group is detected to determine whether the corresponding network device interfaces are connected with the network devices, and the preboot execution environment control functions of the reference network devices correspondingly connected to the plurality of reference network device interfaces in the network device interface group are disabled.

### BRIEF DESCRIPTION OF THE DRAWINGS

FIG. 1 is a block diagram of a hardware structure of a server device of a server booting method according to some embodiments of the present disclosure;

FIG. 2 is a flowchart of a server booting method according to some embodiments of the present disclosure;

FIG. 3 is a schematic diagram of a server according to some embodiments of the present disclosure;

FIG. 4 is a schematic diagram of a server booting flow according to some embodiments of the present disclosure;

FIG. 5 is a swim lane diagram of a server booting flow according to some embodiments of the present disclosure;

FIG. 6 is a structural block diagram of a server booting apparatus according to some embodiments of the present disclosure;

FIG. 7 is a structural block diagram of a computer program product according to some embodiments of the present disclosure;

FIG. 8 is a structural block diagram of a non-transitory computer storage medium according to some embodiments of the present disclosure; and

FIG. 9 is a structural block diagram of an electronic device according to some embodiments of the present disclosure.

### DETAILED DESCRIPTION OF THE EMBODIMENTS

Embodiments of the present disclosure will be described in detail below with reference to the drawings and in conjunction with the embodiments.

It should be noted that the terms “first” and “second” and the like in the specification, the claims and the above drawings of the present disclosure are used for distinguishing similar objects, and are not necessarily used for describing a specific sequence or precedence order.

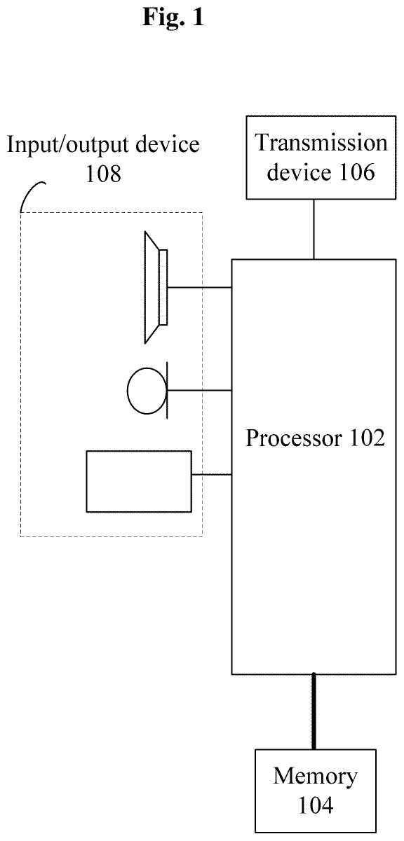

Method embodiments provided in the embodiments of the present disclosure may be executed in a server device or a similar computing apparatus. Taking the operation on a server device as an example, FIG. 1 is a block diagram of a hardware structure of a server device of a server booting method according to some embodiments of the present disclosure. As shown in FIG. 1, the server device may include one or more (only one is shown in FIG. 1) processors 102 (each of the one or more processors 102 may include, but is not limited to, a processing apparatus such as a Microcontroller Unit (MCU) or a Field Programmable Gate Array (FPGA)), and a memory 104 configured to store data. The server device may further include a transmission device 106 for a communication function, and an input/output device 108. Those having ordinary skill in the art may understand that the structure shown in FIG. 1 is merely schematic, and does not limit the structure of the server device. For example, the server device may further include more or fewer components than those shown in FIG. 1, or have a configuration different from that shown in FIG. 1.

The memory 104 may be configured to store computer-readable instructions, for example, software programs and modules of application software, for example, computer-readable instructions corresponding to the server booting method in the embodiments of the present disclosure. The one or more processors 102 execute various functional applications and data processing, that is, implement the above method by running the computer-readable instructions stored in the memory 104. The memory 104 may include a high-speed random access memory, and may further include a non-transitory memory, such as one or more magnetic storage apparatuses, a flash memory, or other non-transitory solid-state memories. In some instances, the memory 104 may further include memories that are disposed remotely relative to the one or more processors 102, and these remote memories may be connected to the server device by a network. Instances of the network include, but are not limited to, the Internet, an intranet, a local area network, a mobile communication network, and combinations thereof.

The transmission device 106 is configured to receive or send data via a network. Instances of the above network may include a wireless network provided by a communication provider of the server device. In some instances, the transmission device 106 includes a Network Interface Controller (NIC), which may be connected with other network devices via a base station to communicate with the Internet. In some instances, the transmission device 106 may be a Radio Frequency (RF) module, which is configured to communicate with the Internet in a wireless manner.

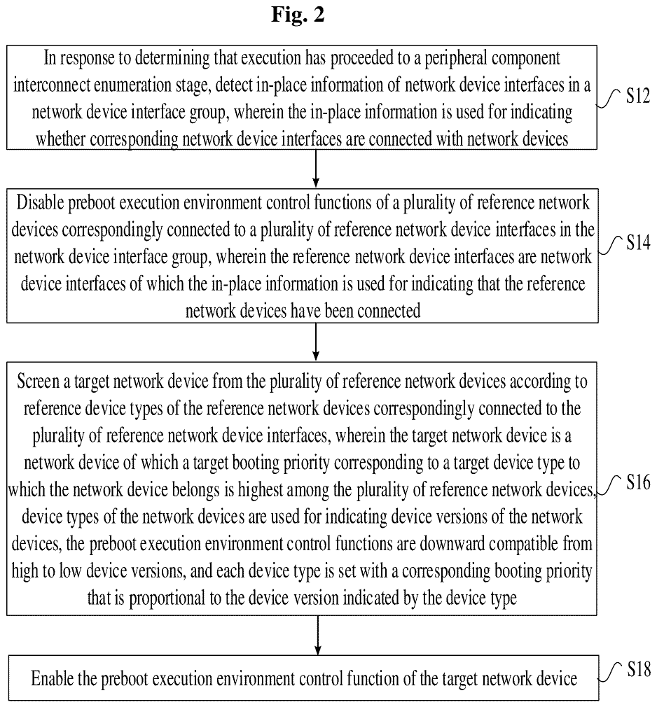

The present embodiment provides a server booting method. FIG. 2 is a flowchart of a server booting method according to some embodiments of the present disclosure. As shown in FIG. 2, the server booting method is applied to a basic input output system installed in a server, a network device interface group is deployed on the server, network device interfaces in the network device interface group are used for connecting network devices, the network devices have preboot execution environment control functions, and the flow of the server booting method includes the following operations S12 to S18.

In operation S12, in response to determining that execution has proceeded to a peripheral component interconnect enumeration stage, in-place information of the network device interfaces in the network device interface group is detected, wherein the in-place information is used for indicating whether corresponding network device interfaces are connected with the network devices.

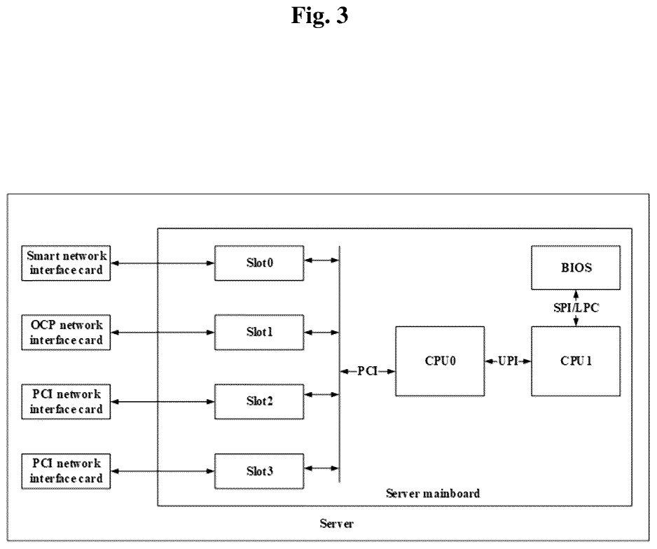

In some embodiments, FIG. 3 is a schematic diagram of a server according to some embodiments of the present disclosure. As shown in FIG. 3, a complete machine of the server includes a server mainboard and network interface cards connected to the server mainboard, wherein the network interface cards are connected to expansion slots (Slot 0 to Slot 3, which are only examples, the number of the expansion slots and the connected network interface cards may be adjusted according to actual needs), the expansion slots are connected with a Central Processing Unit (CPU) 0 via a Peripheral Component Interconnect (PCI) bus, the CPU 0 establishes a connection with a BIOS via a CPU 1, the CPU 0 is connected with the CPU 1 via a Ultra Path Interconnect (UPI) bus, and the CPU 1 is connected with a Basic input output system (BIOS) via a Serial Peripheral Interface/Low Power Interface (SPI/LPI) bus. The server booting method is applied to a basic input output system installed in the server, and the basic input output system may be, but is not limited to, the BIOS in FIG. 3.

In some embodiments, the network device interface may be, but is not limited to, a network interface, and the network device may be, but is not limited to, a network interface card. As shown in FIG. 3, in a case where the network device is a network interface card, the network device may be, but is not limited to, a smart network interface card, an Open Compute Project network interface card (short as an OCP network interface card), and a Peripheral Component Interconnect network interface card (short as a PCI network interface card). The smart network interface card, the open compute project network interface card and the peripheral component interconnect network interface card all have preboot execution environment control functions.

In some embodiments, the preboot execution environment control function may be, but is not limited to, a Preboot Execution Environment (PXE) function.

In operation S14, the preboot execution environment control functions of a plurality of reference network devices correspondingly connected to a plurality of reference network device interfaces in the network device interface group are disabled, wherein the reference network device interfaces are network device interfaces of which the in-place information is used for indicating that the reference network devices have been connected.

In some embodiments, taking FIG. 3 as an example, the smart network interface card, the OCP network interface card and the PCI network interface card are connected to the network device interface group of the server. The smart network interface card, the OCP network interface card and the PCI network interface card are all reference network devices, and the preboot execution environment control functions of the smart network interface card, the OCP network interface card and the PCI network interface card are disabled. In the present disclosure, the server booting method is described by taking it as an example that the network devices deployed on the server include the smart network interface card, the OCP network interface card and the PCI network interface card. The network devices may also be a Host Bus Adapter (HBA) network interface card and a Host Channel Adaptor (HCA) network interface card. Since the function and rate of each type of network interface card are different, different network interface cards configured on the server have different service requirements, for example, the smart network interface card is deployed mainly for achieving a virtual cloud service, the OCP network interface card is deployed mainly for achieving network data exchange, the PCI network interface card is deployed mainly for achieving traditional information transmission. The network interface cards perform network information transmission regardless of the type. However, in the server configured with the smart network interface card, a PXE function needs to enabled on the smart network interface card to install a cloud system, and if the PXE function is enabled on a network of a non-smart network interface card to install the system, the system is installed in a local storage hard disk, such that the cloud system cannot be booted. The server booting method provided in the embodiments of the present disclosure may overcome the problem of relatively low compatibility between the preboot execution environment control functions enabled during the booting of the server and the network devices in the server.

In operation S16, a target network device is screened from the plurality of reference network devices according to reference device types of the reference network devices correspondingly connected to the plurality of reference network device interfaces, wherein the target network device is a network device of which a target booting priority corresponding to a target device type to which the network device belongs is highest among the plurality of reference network devices, device types of the network devices are used for indicating device versions of the network devices, the preboot execution environment control functions are downward compatible from high to low device versions, and each device type is set with a corresponding booting priority that is proportional to the device version indicated by the device type.

In some embodiments, the device types of the network devices are used for indicating the device versions of the network devices, the preboot execution environment control functions are downward compatible from high to low device versions. With the smart network interface card, the OCP network interface card and the PCI network interface card as an example, the device versions are sequentially as follows from high to low: the smart network interface card, the OCP network interface card and the PCI network interface card. The preboot execution environment control function of the smart network interface card is able to be compatible with the normal operation of the smart network interface card, the OCP network interface card and the PCI network interface card; the preboot execution environment control function of the OCP network interface card is able to be compatible with the normal operation of the OCP network interface card and the PCI network interface card, but is unable to be compatible with the normal operation of the smart network interface card; and the preboot execution environment control function of the PCI network interface card is only able to be compatible with the normal operation of the PCI network interface card, but is unable to be compatible with the normal operation of the smart network interface card and the OCP network interface card. Since each device type is set with a corresponding booting priority that is proportional to the device version indicated by the device type, the booting priorities are sequentially as follows from high to low: the smart network interface card, the OCP network interface card and the PCI network interface card.

In some embodiments, the preboot execution environment control function of the smart network interface card being able to be compatible with the normal operation of the smart network interface card, the OCP network interface card and the PCI network interface card may be understood as that an operating system installed in the server by enabling the preboot execution environment control function of the smart network interface card may support the normal operation of the smart network interface card, the OCP network interface card and the PCI network interface card.

In some embodiments, the preboot execution environment control function of the OCP network interface card being able to be compatible with the normal operation of the OCP network interface card and the PCI network interface card, but being unable to be compatible with the normal operation of the smart network interface card may be understood as that an operating system installed in the server by enabling the preboot execution environment control function of the OCP network interface card cannot support the normal operation of the smart network interface card, but may support the normal operation of the OCP network interface card and the PCI network interface card.

In some embodiments, the preboot execution environment control function of the PCI network interface card being only able to be compatible with the normal operation of the PCI network interface card, but being unable to be compatible with the normal operation of the smart network interface card and the OCP network interface card may be understood as that an operating system installed in the server by enabling the preboot execution environment control function of the PCI network interface card cannot support the normal operation of the smart network interface card and the OCP network interface card, but may support the normal operation of the PCI network interface card.

It is worth noting that the operating system installed in the server by enabling the preboot execution environment control function of the smart network interface card is a cloud system, and the cloud system is installed in the smart network interface card; the operating systems installed in the server by enabling the preboot execution environment control functions of the OCP network interface card and the PCI network interface card are local systems, which are installed in the local storage hard disk.

In operation S18, the preboot execution environment control function of the target network device is enabled.

In the embodiments of the present disclosure, a server booting method is provided, which is applied to the basic input output system installed in the server, the network device interface group is deployed on the server, the network device interfaces in the network device interface group are used for connecting the network devices, the network devices have the preboot execution environment control functions, in response to determining that execution of a booting process of the server has proceeded to the peripheral component interconnect enumeration stage, the in-place information of the network device interfaces in the network device interface group is detected to determine whether the corresponding network device interfaces are connected with the network devices, the preboot execution environment control functions of the reference network devices correspondingly connected to the plurality of reference network device interfaces in the network device interface group are disabled, and the reference network device interfaces are network device interfaces of which the in-place information is used for indicating that the reference network devices have been connected, thereby avoiding the occurrence of a situation in the related art in which the preboot execution environment control functions of the reference network devices are directly enabled upon detecting that the reference network devices are connected to the reference network device interfaces, and thus avoiding relatively low compatibility between the enabled preboot execution environment control functions and the network devices in the server; and further, the target network device is screened from the plurality of reference network devices according to the reference device types of the reference network devices correspondingly connected to the plurality of reference network device interfaces, wherein the target network device is the network device of which the target booting priority corresponding to the target device type to which the network device belongs is highest among the plurality of reference network devices, the device types of the network devices are used for indicating the device versions of the network devices, the preboot execution environment control functions are downward compatible from high to low device versions, and each device type is set with a corresponding booting priority that is proportional to the device version indicated by the device type. By enabling the preboot execution environment control function of the target network device, it can be ensured that the enabled preboot execution environment control function can be compatible with the current network device of the server. By using the above technical solutions, the problem in the related art of relatively low compatibility between the preboot execution environment control functions enabled during the booting of the server and the network devices in the server is solved, and the technical effect of improving the compatibility between the preboot execution environment control functions enabled during the booting of the server and the network devices in the server is achieved.

In some embodiments, the operation that, in response to determining that the network devices are network interface card devices, the target network device is screened from the plurality of reference network devices according to the reference device types of the reference network devices correspondingly connected to the plurality of reference network device interfaces includes the following operations S21 to S24.

In operation S21, the device type of each reference network device among the plurality of reference network devices is identified until all of the plurality of reference network devices are identified, so as to obtain a plurality of reference device types.

In operation S22, in response to determining that the plurality of reference device types include a smart network interface card type, a network interface card device of the smart network interface card type among the plurality of reference device types is determined as the target network device having the highest booting priority.

In operation S23, in response to determining that the plurality of reference device types do not include the smart network interface card type, but include an open compute project network interface card type, a network interface card device of the open compute project network interface card type among the plurality of reference device types is determined as the target network device having the highest booting priority.

In operation S24, in response to determining that the plurality of reference device types do not include the smart network interface card type and the open compute project network interface card type, but include a peripheral component interconnect network interface card type, a network interface card device of the peripheral component interconnect network interface card type among the plurality of reference device types is determined as the target network device having the highest booting priority.

In some embodiments, taking the following scenario as an example, the plurality of reference network device interfaces include: an interface 1, an interface 2, an interface 3, an interface 4, an interface 5 and an interface 6, wherein the following reference network devices are respectively connected through the plurality of reference network device interfaces: a device 1, a device 2, a device 3, a device 4, a device 5 and a device 6.

The device type of each reference network device among the plurality of reference network devices is identified until all of the plurality of reference network devices are identified to obtain the plurality of reference device types, that is, the device types of the device 1, the device 2, the device 3, the device 4, the device 5 and the device 6 are identified until the reference network devices among the device 1, the device 2, the device 3, the device 4, the device 5 and the device 6 are identified so as to obtain six reference device types.

In response to determining that the six reference device types include the smart network interface card type, for example, the device 3 is a smart network interface card, and the smart network interface card is determined as the target network device having the highest booting priority. In response to determining that there are a plurality of smart network interface cards, the first identified smart network interface card may be determined as the target network device, or one smart network interface card is randomly selected from the plurality of smart network interface cards as the target network device. In response to determining that the six reference device types do not include the smart network interface card type, but include the open compute project network interface card type, for example, the device 1 is an open compute project network interface card, and the open compute project network interface card is determined as the target network device having the highest booting priority. In response to determining that there are a plurality of open compute project network interface cards, the first identified open compute project network interface card may be determined as the target network device, or, one open compute project network interface card is randomly selected from the plurality of open compute project network interface cards as the target network device. In response to determining that the six reference device types do not include the smart network interface card type and the open compute project network interface card type, but include a peripheral component interconnect network interface card type, for example, the device 6 is a peripheral component interconnect network interface card, and the peripheral component interconnect network interface card is determined as the target network device having the highest booting priority. In response to determining that there are a plurality of peripheral component interconnect network interface cards, the first identified peripheral component interconnect network interface card may be determined as the target network device, or one peripheral component interconnect network interface card is randomly selected from the plurality of peripheral component interconnect network interface cards as the target network device.

In some embodiments, the operation that, in response to determining that the network devices are network interface card devices, the target network device is screened from the plurality of reference network devices according to the reference device types of the reference network devices correspondingly connected to the plurality of reference network device interfaces may further include the following operations S31 to S37.

In operation S31, a current candidate network device to be identified is extracted from the plurality of reference network devices.

In operation S32, the device type of the candidate network device is identified to obtain a candidate device type, wherein the reference device types include the candidate device type.

In operation S33, whether the candidate device type is a smart network interface card type is determined.

In operation S34, in response to determining that the candidate device type is the smart network interface card type, the identification ends in advance, and the candidate network device is determined as the target network device having the highest booting priority.

In operation S35, in response to determining that the candidate device type is not the smart network interface card type, a next reference network device that has not yet been identified continues to be extracted from the plurality of reference network devices as the current candidate network device to be identified, until there is no reference network device that has not yet been identified among the plurality of reference network devices, and the identification ends to obtain a plurality of candidate device types.

In operation S36, in response to determining that the plurality of candidate device types include an open compute project network interface card type, a network interface card device of the open compute project network interface card type among the plurality of reference network devices is determined as the target network device having the highest booting priority.

In operation S37, in response to determining that the plurality of candidate device types do not include the open compute project network interface card type, but include a peripheral component interconnect network interface card type, a network interface card device of the peripheral component interconnect network interface card type among the plurality of reference network devices is determined as the target network device having the highest booting priority.

In some embodiments, different from the mode represented by operations S21 to S24 in which the reference device types of the reference network devices are first identified, and then the target network device is screened out according to the reference device types, the operations S31 to S37 represent another mode in which every time the type of one reference network device (i.e. the candidate network device) among the plurality of reference network devices is detected, it is immediately judged whether the type is the smart network interface card type after the detection, in response to determining that the type is the smart network interface card type, the currently detected reference network device of the smart network interface card type is directly determined as the target network device, and in response to determining that there is no smart network interface card type after the plurality of reference network devices are detected, the target network device is screened out according to the reference device types.

In some embodiments, the operation that the preboot execution environment control functions of the reference network devices correspondingly connected to the plurality of reference network device interfaces in the network device interface group are disabled includes the following operation S41.

In operation S41, network interface parameters corresponding to the plurality of reference network device interfaces are updated to a first network interface parameter, wherein the first network interface parameter is used for instructing the corresponding reference network device interfaces to disable the preboot execution environment control functions of the reference network devices connected to the corresponding reference network device interfaces.

In some embodiments, the mode for updating the network interface parameters corresponding to the plurality of reference network device interfaces to the first network interface parameter may be, but is not limited to, sending, by the BIOS, a first update instruction carrying the first network interface parameter to the corresponding reference network device interfaces.

In some embodiments, the operation that the preboot execution environment control function of the target network device is enabled may further include the following operations S51 and S52.

In operation S51, a target network device interface corresponding to the target network device is located from the plurality of reference network device interfaces.

In operation S52, a network interface parameter of the target network device interface is updated to a second network interface parameter, wherein the second network interface parameter is used for instructing the target network device interface to enable the preboot execution environment control function of the connected target network device.

In some embodiments, the mode for updating the network interface parameter of the target network device interface to the second network interface parameter may be, but is not limited to, sending, by the BIOS, a second update instruction carrying the second network interface parameter to the corresponding target network device interface.

In some embodiments, the server booting method may further include the following operation S61 after disabling the preboot execution environment control functions of the reference network devices correspondingly connected to the plurality of reference network device interfaces in the network device interface group.

In operation S61, a control option is created for each reference network device interface among the plurality of reference network device interfaces on a basic input output system interface of the basic input output system, wherein each control option is used for controlling the corresponding reference network device interface to enable or disable the preboot execution environment control function of the reference network device connected to the corresponding reference network device interface.

In some embodiments, taking the following scenario as an example, the plurality of reference network device interfaces include: an interface 1, an interface 2, an interface 3, an interface 4, an interface 5 and an interface 6, wherein the following reference network devices are respectively connected through the plurality of reference network device interfaces: a device 1, a device 2, a device 3, a device 4, a device 5 and a device 6. A control option may be created for each of the interface 1, the interface 2, the interface 3, the interface 4, the interface 5 and the interface 6 on the basic input output system interface of the basic input output system for manual adjustment control.

In some embodiments, the server booting method may further include the following operations S71 and S72 after screening the target network device from the plurality of reference network devices according to the reference device types of the reference network devices correspondingly connected to the plurality of reference network device interfaces.

In operation S71, whether there is a control option which has been subjected to an adjustment operation is detected.

In operation S72, in response to detecting that there is the control option which has been subjected to the adjustment operation, the preboot execution environment control function of the reference network device corresponding to the control option which has been subjected to the adjustment operation is enabled, and other currently enabled preboot execution environment control functions in the server are controlled to be disabled.

In some embodiments, taking the following scenario as an example, the plurality of reference network device interfaces include: an interface 1, an interface 2, an interface 3, an interface 4, an interface 5 and an interface 6, wherein the following reference network devices are respectively connected through the plurality of reference network device interfaces: a device 1, a device 2, a device 3, a device 4, a device 5 and a device 6. It is assumed that the target network device is the device 1. In response to determining that the adjustment operation is executed on the control option corresponding to the interface 2, the preboot execution environment control function of the device 2 connected to the interface 2 is enabled, and the other currently enabled preboot execution environment control functions (e.g., the preboot execution environment control function of the device 1) in the server are controlled to be disabled.

In some embodiments, the server booting method may further include the following operations S81 to S83 after screening the target network device from the plurality of reference network devices according to the reference device types of the reference network devices correspondingly connected to the plurality of reference network device interfaces.

In operation S81, whether there is a control option which has been subjected to an adjustment operation is detected.

In operation S82, in response to detecting that there is the control option which has been subjected to the adjustment operation, a candidate network device interface corresponding to the control option which has been subjected to the adjustment operation is acquired from the plurality of reference network device interfaces, and a target confirmation instruction is generated, wherein the target confirmation instruction is used for requesting a target account to determine, from an alternative network device connected to the candidate network device interface and the target network device, a network device whose preboot execution environment control function is allowed to be enabled.

In operation S83, target confirmation information returned by the target account is received, and the preboot execution environment control function of the corresponding network device is controlled to be enabled according to the target confirmation information, wherein the target confirmation information is used for indicating the network device whose preboot execution environment control function is allowed to be enabled.

In some embodiments, taking the following scenario as an example, the plurality of reference network device interfaces include: an interface 1, an interface 2, an interface 3, an interface 4, an interface 5 and an interface 6, wherein the following reference network devices are respectively connected through the plurality of reference network device interfaces: a device 1, a device 2, a device 3, a device 4, a device 5 and a device 6. It is assumed that the target network device is the device 1. In response to determining that the adjustment operation is executed on the control option corresponding to the interface 2, the interface 2 is determined to be the candidate network device interface, and the target confirmation instruction is generated, wherein the target confirmation instruction is used for requesting the target account to determine, from the device 2 connected to the interface 2 and the device 1, the network device whose preboot execution environment control function is allowed to be enabled; and in response to determining that the target confirmation information returned by the target account is used for indicating that the preboot execution environment control function of the device 2 is allowed to be enabled, the preboot execution environment control function of the device 2 connected to the interface 2 is enabled, and the preboot execution environment control function of the device 1 is controlled to be disabled.

In some embodiments, the operation that the target network device is screened from the plurality of reference network devices according to the reference device types of the reference network devices correspondingly connected to the plurality of reference network device interfaces may further include the following operations S91 and S92.

In operation S91, device types of the reference network devices correspondingly connected to the plurality of reference network device interfaces are detected to obtain the reference device types.

In operation S92, the target network device is screened from the plurality of reference network devices according to the detected reference device types.

In some embodiments, the operation that the device types of the reference network devices correspondingly connected to the plurality of reference network device interfaces are detected to obtain the reference device types may further include the following operations S101 and S102.

In operation S101, device identification messages are read from the reference network devices correspondingly connected to the plurality of reference network device interfaces, wherein the device identification messages are used for indicating the device types of the corresponding reference network devices.

In operation S102, the device identification messages are parsed to obtain the reference device types of the reference network devices.

In some embodiments, one mode for detecting the device types of the reference network devices is to directly and actively read, by the BIOS and from the reference network devices, the device identification messages used for indicating the device types of the corresponding reference network devices.

In some embodiments, the operation that the device types of the reference network devices correspondingly connected to the plurality of reference network device interfaces are detected to obtain the reference device types may further include the following operations S111 and S112.

In operation S111, a target request instruction is sent to the reference network devices correspondingly connected to the plurality of reference network device interfaces, wherein the target request instruction is used for requesting the reference network devices correspondingly connected to the plurality of reference network device interfaces to send device identification messages to the basic input output system, and the device identification messages are used for indicating the device types of the corresponding reference network devices.

In operation S112, the device identification messages sent by the reference network devices correspondingly connected to the plurality of reference network device interfaces are received, and the device identification messages are parsed to obtain the reference device types of the reference network devices.

In some embodiments, another mode for detecting the device types of the reference network devices is to send, by the BIOS and to the reference network devices, the target request instruction used for requesting the device identification messages, and receive the device identification messages used for indicating the device types of the corresponding reference network devices.

After receiving the device identification messages, the BIOS may determine the reference device type corresponding to the currently read device identification message according to the device identification messages and the device types, which have a correspondence, or may identify specific fields in the device identification messages to judge the reference device types.

In some embodiments, the operation that the device types of the reference network devices correspondingly connected to the plurality of reference network device interfaces are detected to obtain the reference device types may further include the following operation S121.

In operation S121, the device types of the reference network devices correspondingly connected to the plurality of reference network device interfaces are sequentially detected according to a target detection sequence, so as to obtain the reference device types, wherein the target detection sequence records a detection sequence of the plurality of reference network device interfaces, in the target detection sequence, the higher a rank of the reference network device interface is, the higher a reference device version of the network device allowed to be connected to the reference network device interface is, and the reference device version is the highest device version of the network device allowed to be connected to the corresponding reference network device interface.

In some embodiments, taking the following scenario as an example, the plurality of reference network device interfaces include: an interface 1, an interface 2, an interface 3, an interface 4, an interface 5 and an interface 6, wherein the following reference network devices are respectively connected through the plurality of reference network device interfaces: a device 1, a device 2, a device 3, a device 4, a device 5 and a device 6. The device types of the reference network devices correspondingly connected to the plurality of reference network device interfaces may be detected according to the target detection sequence, so as to obtain the reference device types, the target detection sequence may be preset, and the principle is followed in which the higher the rank of the reference network device interface is, the higher the reference device version of the network device allowed to be connected to the reference network device interface is. For example, the target detection sequence may be: the device 3, the device 4, the device 1, the device 2, the device 5 and the device 6. Then, the device types of the reference network devices connected to the device 3, the device 4, the device 1, the device 2, the device 5 and the device 6 are detected in sequence.

In some embodiments, the server booting method may further include the following operations S131 to S133 in response to determining that the network devices are network interface card devices and before sequentially detecting, according to the target detection sequence, the device types of the reference network devices correspondingly connected to the plurality of reference network device interfaces to obtain the reference device types.

In operation S131, in response to determining that the plurality of reference network device interfaces include a first network device interface, a second network device interface and a third network device interface, a first detection sequence is constructed in an order of the first network device interface, the second network device interface and the third network device interface, wherein the target detection sequence includes the first detection sequence.

In operation S132, in response to determining that the plurality of reference network device interfaces include the first network device interface and the third network device interface, a second detection sequence is constructed in an order of the first network device interface and the third network device interface, wherein the target detection sequence includes the second detection sequence.

In operation S133, in response to determining that the plurality of reference network device interfaces include the second network device interface and the third network device interface, a third detection sequence is constructed in an order of the second network device interface and the third network device interface, wherein the target detection sequence includes the third detection sequence.

In this embodiment, the network device of the highest device version allowed to be connected to the first network device interface is a network interface card device of a smart network interface card type, the network device of the highest device version allowed to be connected to the second network device interface is a network interface card device of an open compute project network interface card type, the network device of the highest device version allowed to be connected to the third network device interface is a network interface card device of a peripheral component interconnect network interface card type, the device version of the network interface card device indicated by the smart network interface card type is higher than the device version of the network interface card device indicated by the open compute project network interface card type, and the device version of the network interface card device indicated by the open compute project network interface card type is higher than the device version of the network interface card device indicated by the peripheral component interconnect network interface card type.

In some embodiments, the network device of the highest device version allowed to be connected to the first network device interface is the network interface card device of the smart network interface card type, for example, the interface 3 and the interface 4, wherein the interface 3/interface 4 may be connected with a smart network interface card, an OCP network interface card and a PCI network interface card, and the device versions are sequentially as follows from high to low: the smart network interface card, the OCP network interface card and the PCI network interface card; the network device of the highest device version allowed to be connected to the second network device interface is the network interface card device of the open compute project network interface card type, for example, the interface 1 and the interface 2, wherein the interface 1/interface 2 may be connected with the OCP network interface card and the PCI network interface card; and the network device of the highest device version allowed to be connected to the third network device interface is the network interface card device of the peripheral component interconnect network interface card type, for example, the interface 5 and the interface 6, wherein the interface 5/interface 6 may only be connected with the PCI network interface card.

In some embodiments, in order to better understand the booting process of the server, the booting flow of the server is described below in combination with the embodiments, but the technical solutions of the embodiments of the present disclosure are not limited thereto.

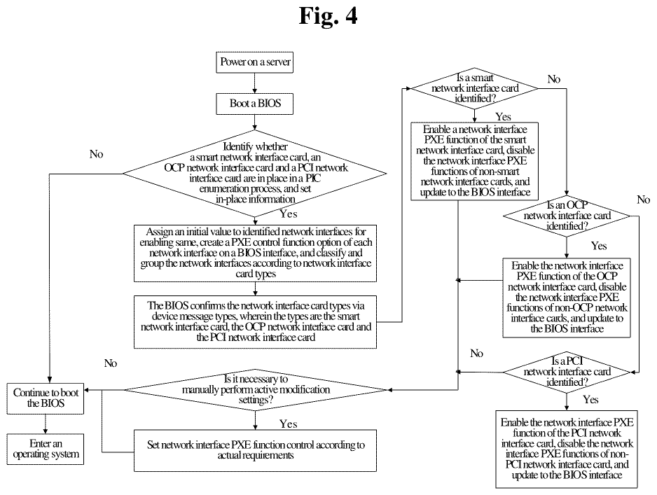

The present embodiment provides a server booting method, FIG. 4 is a schematic diagram of a server booting flow according to some embodiments of the present disclosure, and as shown in FIG. 4, the server booting flow mainly includes the following operations S401 to S407.

In operation S401, in response to determining that a server is booted, a BIOS performs identification and judgment on network interface card types in a PCI enumeration stage, and sets in-place information for a smart network interface card, an OCP network interface card and a PCI interface network interface card.

In operation S402, an initial value (i.e., the first network interface parameter) is assigned to network interfaces of identified network interface cards of various types, a network interface card PXE function setting option (which is equivalent to a control option) of each network interface is created, the network interface card PXE function setting option is displayed on a BIOS interface (basic input output system interface), and a network interface card booting classification group (which is equivalent to a target detection sequence) is updated.

In operation S403, after the network interface card booting classification group is created, the network interface card types are confirmed via device identification messages of the network interface card types.

In operation S404, in response to determining and identifying that the smart network interface card is present, a network interface PXE function of the smart network interface card is enabled, the network interface PXE function of remaining OCP network interface card(s) or PCI network interface card(s) is disabled, meanwhile the initial value of the network interfaces is updated and a disabling function is set, and information about the enablement of the PXE function of the smart network interface card and the disablement of the PXE functions of the remaining network interfaces is displayed on the BIOS interface.

In operation S405, in response to determining and identifying that the smart network interface card is not present and that the OCP network interface card and the standard PCI network interface card are present, the network interface PXE function of the OCP network interface card is enabled, the network interface PXE function of the PCI network interface card is disabled, meanwhile the initial value of the network interfaces is updated and the disabling function is set, and information about the enablement of the PXE function of the OCP network interface card and the disablement of the PXE functions of the remaining network interfaces is displayed on the BIOS interface.

In operation S406, in response to determining and identifying that the OCP network interface card is not present and that the standard PCI network interface card is present, the PXE function of the network interface of the identified PCI network interface card is enabled, and meanwhile, information about the enablement of the network interface PXE function of the PCI network interface card is displayed on the BIOS interface.

In operation S407, the network interface PXE functions are automatically enabled or disabled in operations 4-6, and on the basis of operations 4-6, the enabling or disabling of the PXE functions of the network interfaces may be manually adjusted.

FIG. 5 is a swim lane diagram of a server booting flow according to some embodiments of the present disclosure. As shown in FIG. 5, the server booting flow involves a server, a BIOS and network interface control, and PXE functions of network interfaces of the server are controlled by running the server booting method via the BIOS, so as to install an operating system in the server to implement the whole process of powering on the server to entering the operating system.

According to the server booting method provided in the embodiment of the present disclosure, a solution for disabling or enabling network interface functions is designed in combination with applied network interface card types, that is, when the smart network interface card, the OCP network interface card and the standard PCI network interface card are all configured in the server system, no matter which network interface is first identified, the network interface PXE function of the smart network interface card is enabled, the network interface PXE functions of the remaining network interface cards are disabled, and the PXE functions are controlled in the manner of control options on the BIOS interface; when there is no smart network interface card, and there are the OCP network interface card and other standard PCI network interface cards, no matter which network interface is identified first, the network interface PXE function of the OCP network interface card is enabled, the network interface PXE functions of the remaining network interface cards are disabled, and the PXE functions are controlled in the manner of control options on the BIOS interface; when there are no smart network interface card and OCP network interface card, and there is the standard PCI network interface card, the network interface PXE function of the first identified network interface card is enabled, the network interface PXE functions of the remaining network interface cards are disabled, and the PXE functions are controlled in the manner of control options on the BIOS interface. If it is necessary to support the requirement of enabling the PXE functions for both the smart network interface card and the OCP network interface card when both the smart network interface card and the OCP network interface card are in place, the network interface PXE functions of the smart network interface card and the OCP network interface card are enabled in the same manner, the network interface PXE functions of the remaining network interface card are disabled, and the PXE functions are controlled in the manner of control options on the BIOS interface.

The embodiment of the present disclosure relates to a method for dynamically controlling the booting of a network interface PXE. The server booting method includes: in response to determining that a server is booted, identifying in-place information of network interface card types in a PCI device in a PCI enumeration stage of a BIOS, such as a smart network interface card, an OCP network interface card and a standard PCI network interface card; setting PXE default enabling of the network interface cards according to an identification result, and creating a BIOS interface control option of each network interface; meanwhile, according to a message type of the PCI device, identifying the network interface card types, such as the smart network interface card, the OCP network interface card and the standard network interface card, which are identified in the booting process; and respectively setting network interface PXE functions of different identified network cards according to the priorities of network card devices. Meanwhile, it is supported to manually perform particular settings on the enabling of the network interface PXE functions for the use of a particular environment in a BIOS booting process. In the solution provided in the embodiment of the present disclosure, in response to determining PCI enumeration, the BIOS sets and updates a BIOS interface display option according to the in-place information of the devices and desired priorities of enabling the network interface PXE functions, and when there is a special requirement, the network interface PXE functions may be set by the BIOS interface, and the requirement of automatically controlling the PXE functions by the BIOS is ignored.

In the solution provided in the embodiments of the present disclosure, when the BIOS is booted, the in-place information of the smart network interface card, the OCP network interface card and the standard PCI network interface card is identified in the PCI enumeration process, meanwhile, BIOS options are created for the network interfaces of the identified network interface cards of various types and are set to be enabled by default, the network interface card of which type is present is then confirmed according to a device message type, different BIOS option setting functions are set according to different requirements of different network interface card types for enabling the PXE functions, meanwhile, it is supported to manually and separately set a requirement for enabling or disabling a particular network interface function, not only automatic identification of the network cards enabling the PXE functions is supported, but it is also supported to modify a PXE setting function according to a particular requirement. The solution provided in the embodiments of the present disclosure is applicable to server products of any architecture.

The solution provided in the embodiments of the present disclosure has high replicability and expandability. When the server is booted, the BIOS identifies the in-place information of the smart network interface card, the OCP network interface card and the standard PCI network interface card during PCI enumeration, meanwhile the enabling of the network interface PXE functions is set, the control option of each network interface PXE function is added to the BIOS interface and is set to be enabled; then, the current network interface card type is confirmed by the message type of the network interface card device, in response to determining that the current network interface card type is the smart network interface card, the PXE function of the smart network interface card is enabled, and the PXE functions of other non-smart network interface cards are disabled; in response to determining that the smart network interface card is not identified and the OCP network interface card is identified, the PXE function of the OCP network interface card is used, and the PXE functions of other non-OCP network interface cards are disabled; and in response to determining that the smart network interface card and the OCP network interface card are not identified, all network interface PXE functions are enabled. At the same time, the corresponding network interface PXE functions are correspondingly set and displayed on the BIOS interface, when it is necessary to manually modify any PXE function that does not meet the above expectation, a specific network interface PXE function may be enabled on the BIOS interface, and the solution of automatically controlling the PXE function may be ignored. In this way, the solution can be conveniently and quickly adjusted by the research and development personnel and the operation and maintenance personnel according to actual service requirements. The solution supports server products of any architecture, and has strong universality and high applicability.

By means of the descriptions of the above implementations, those having ordinary skill in the art may clearly understand that, the server booting method according to the above embodiments may be implemented by software plus a necessary universal hardware platform, and of course may also be implemented by hardware, but the former is a better implementation in many cases. Based on such an understanding, the essence of the technical solutions of the embodiments of the present disclosure or the part contributing to the related art may be embodied in the form of a software product. The computer software product is stored in a storage medium (e.g., an Read-Only Memory (ROM)/Random Access Memory (RAM), a magnetic disk and an optical disk), and includes several instructions for enabling a terminal device (which may be a mobile phone, a computer, a server, or a network device, and the like) to execute the server booting method in various embodiments of the present disclosure.

The present embodiment further provides a server booting apparatus, the server booting apparatus is configured to implement the above embodiments, and thus what has been described will not be repeated herein again. As used below, the term “module” may implement a combination of software and/or hardware of a predetermined function. Although the server booting apparatus described in the following embodiments is preferably implemented in software, the implementation of hardware or a combination of software and hardware is also possible and conceivable.

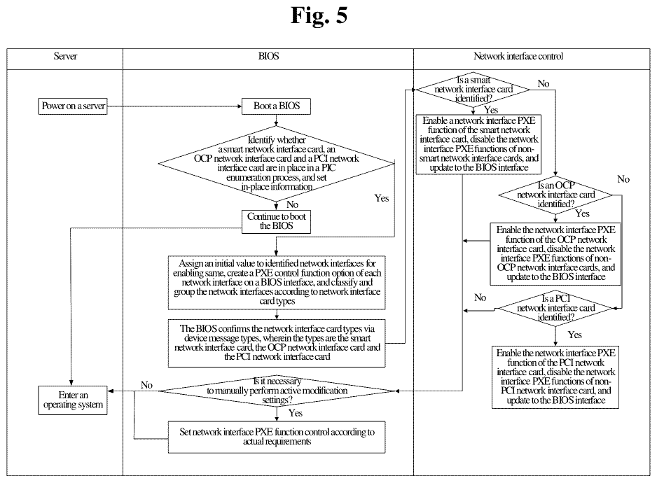

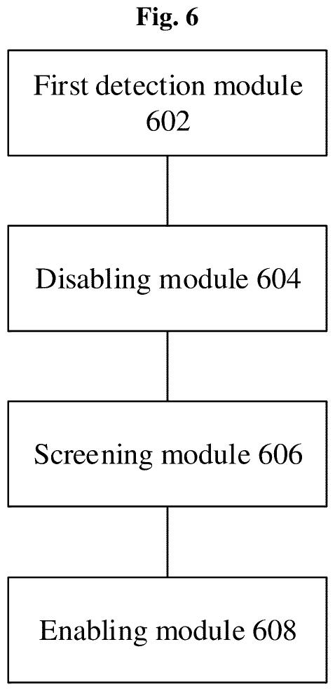

FIG. 6 is a structural block diagram of a server booting apparatus according to some embodiments of the present disclosure. As shown in FIG. 6, the server booting apparatus is applied to a basic input output system installed in a server, a network device interface group is deployed on the server, network device interfaces in the network device interface group are used for connecting network devices, the network devices have preboot execution environment control functions, and the server booting apparatus includes:
a first detection module 602, configured to: in response to determining that execution has proceeded to a peripheral component interconnect enumeration stage, detect in-place information of the network device interfaces in the network device interface group, wherein the in-place information is used for indicating whether corresponding network device interfaces connected with the network devices;
a disabling module 604, configured to disable the preboot execution environment control functions of a plurality of reference network devices correspondingly connected to a plurality of reference network device interfaces in the network device interface group, wherein the reference network device interfaces are network device interfaces of which the in-place information is used for indicating that the reference network devices have been connected;
a screening module 606, configured to screen a target network device from the plurality of reference network devices according to reference device types of the reference network devices correspondingly connected to the plurality of reference network device interfaces, wherein the target network device is a network device of which a target booting priority corresponding to a target device type to which the network device belongs is highest among the plurality of reference network devices, device types of the network devices are used for indicating device versions of the network devices, the preboot execution environment control functions are downward compatible from high to low device versions, and each device type is set with a corresponding booting priority that is proportional to the device version indicated by the device type; and
an enabling module 608, configured to enable the preboot execution environment control function of the target network device.

In some embodiments, in response to determining that the network devices are network interface card devices, the screening module includes:
a first identification unit, configured to identify the device type of each reference network device among the plurality of reference network devices until all of the plurality of reference network devices are identified, so as to obtain a plurality of reference device types;
a first determination unit, configured to: in response to determining that the plurality of reference device types include a smart network interface card type, determine a network interface card device of the smart network interface card type among the plurality of reference device types as the target network device having the highest booting priority;
a second determination unit, configured to: in response to determining that the plurality of reference device types do not include the smart network interface card type, but include an open compute project network interface card type, determine a network interface card device of the open compute project network interface card type among the plurality of reference device types as the target network device having the highest booting priority; and
a third determination unit, configured to: in response to determining that the plurality of reference device types do not include the smart network interface card type and the open compute project network interface card type, but include a peripheral component interconnect network interface card type, determine a network interface card device of the peripheral component interconnect network interface card type among the plurality of reference device types as the target network device having the highest booting priority.

In some embodiments, in response to determining that the network devices are network interface card devices, the screening module includes:
a first extraction unit, configured to extract a current candidate network device to be identified from the plurality of reference network devices;
a second identification unit, configured to identify the device type of the candidate network device to obtain a candidate device type, wherein the reference device types include the candidate device type;
a fourth determination unit, configured to determine whether the candidate device type is a smart network interface card type;
a fifth determination unit, configured to: in response to determining that the candidate device type is the smart network interface card type, end the identification in advance, and determine the candidate network device as the target network device having the highest booting priority;
a second extraction unit, configured to: in response to determining that the candidate device type is not the smart network interface card type, continue to extract a next reference network device that has not yet been identified from the plurality of reference network devices as the current candidate network device to be identified, until there is no reference network device that has not yet been identified among the plurality of reference network devices, and end the identification to obtain a plurality of candidate device types;
a sixth determination unit, configured to: in response to determining that the plurality of candidate device types include an open compute project network interface card type, determine a network interface card device of the open compute project network interface card type among the plurality of reference network devices as the target network device having the highest booting priority; and
a seventh determination unit, configured to: in response to determining that the plurality of candidate device types do not include the open compute project network interface card type, but include a peripheral component interconnect network interface card type, determine a network interface card device of the peripheral component interconnect network interface card type among the plurality of reference network devices as the target network device having the highest booting priority.

In some embodiments, the disabling module is configured to:
update network interface parameters corresponding to the plurality of reference network device interfaces to a first network interface parameter, wherein the first network interface parameter is used for instructing the corresponding reference network device interfaces to disable the preboot execution environment control functions of the reference network devices connected to the corresponding reference network device interfaces.

In some embodiments, the enabling module is configured to:
locate, from the plurality of reference network device interfaces, a target network device interface corresponding to the target network device; and
update a network interface parameter of the target network device interface to a second network interface parameter, wherein the second network interface parameter is used for instructing the target network device interface to enable the preboot execution environment control function of the connected target network device.

In some embodiments, the server booting apparatus may further include:
a creation module, configured to: after disabling the preboot execution environment control functions of the reference network devices correspondingly connected to the plurality of reference network device interfaces in the network device interface group, create a control option for each reference network device interface among the plurality of reference network device interfaces on a basic input output system interface of the basic input output system, wherein each control option is used for controlling the corresponding reference network device interface to enable or disable the preboot execution environment control function of the reference network device connected to the corresponding reference network device interface.

In some embodiments, the server booting apparatus may further include:
a second detection module, configured to: after screening the target network device from the plurality of reference network devices according to the reference device types of the reference network devices correspondingly connected to the plurality of reference network device interfaces, detect whether there is a control option which has been subjected to an adjustment operation; and
an enabling module, configured to: in response to detecting that there is the control option which has been subjected to the adjustment operation, enable the preboot execution environment control function of the reference network device corresponding to the control option which has been subjected to the adjustment operation, and control other currently enabled preboot execution environment control functions in the server to be disabled.

In some embodiments, the server booting apparatus may further include:
a third detection module, configured to: after screening the target network device from the plurality of reference network devices according to the reference device types of the reference network devices correspondingly connected to the plurality of reference network device interfaces, detect whether there is a control option which has been subjected to an adjustment operation;
an acquisition module, configured to: in response to detecting that there is the control option which has been subjected to the adjustment operation, acquire, from the plurality of reference network device interfaces, a candidate network device interface corresponding to the control option which has been subjected to the adjustment operation, and generate a target confirmation instruction, wherein the target confirmation instruction is used for requesting a target account to determine, from an alternative network device connected to the candidate network device interface and the target network device, a network device whose preboot execution environment control function is allowed to be enabled; and
a receiving module, configured to receive target confirmation information returned by the target account, and control the preboot execution environment control function of the corresponding network device to be enabled according to the target confirmation information, wherein the target confirmation information is used for indicating the network device whose preboot execution environment control function is allowed to be enabled.

In some embodiments, the screening module includes:
a detection unit, configured to detect device types of the reference network devices correspondingly connected to the plurality of reference network device interfaces to obtain the reference device types; and
a screening unit, configured to screen the target network device from the plurality of reference network devices according to the detected reference device types.

In some embodiments, the detection unit is further configured to:
read device identification messages from the reference network devices correspondingly connected to the plurality of reference network device interfaces, wherein the device identification messages are used for indicating the device types of the corresponding reference network devices; and
parse the device identification messages to obtain the reference device types of the reference network devices.

In some embodiments, the detection unit is further configured to:
send a target request instruction to the reference network devices correspondingly connected to the plurality of reference network device interfaces, wherein the target request instruction is used for requesting the reference network devices correspondingly connected to the plurality of reference network device interfaces to send device identification messages to the basic input output system, and the device identification messages are used for indicating the device types of the corresponding reference network devices; and
receive the device identification messages sent by the reference network devices correspondingly connected to the plurality of reference network device interfaces, and parse the device identification messages to obtain the reference device types of the reference network devices.

In some embodiments, the detection unit is configured to:
sequentially detect, according to a target detection sequence, the device types of the reference network devices correspondingly connected to the plurality of reference network device interfaces to obtain the reference device types, wherein the target detection sequence records a detection sequence of the plurality of reference network device interfaces, in the target detection sequence, the higher a rank of the reference network device interface is, the higher a reference device version of the network device allowed to be connected to the reference network device interface is, and the reference device version is the highest device version of the network device allowed to be connected to the corresponding reference network device interface.

In some embodiments, the server booting apparatus may further include:
a first construction module, configured to: in response to determining that the network devices are network interface card devices, before sequentially detecting, according to the target detection sequence, the device types of the reference network devices correspondingly connected to the plurality of reference network device interfaces to obtain the reference device types, in response to determining that the plurality of reference network device interfaces include a first network device interface, a second network device interface and a third network device interface, construct a first detection sequence in an order of the first network device interface, the second network device interface and the third network device interface, wherein the target detection sequence includes the first detection sequence;
a second construction module, configured to: in response to determining that the plurality of reference network device interfaces include the first network device interface and the third network device interface, construct a second detection sequence in an order of the first network device interface and the third network device interface, wherein the target detection sequence includes the second detection sequence; or
a third construction module, configured to: in response to determining that the plurality of reference network device interfaces include the second network device interface and the third network device interface, construct a third detection sequence in an order of the second network device interface and the third network device interface, wherein the target detection sequence includes the third detection sequence, wherein
the network device of the highest device version allowed to be connected to the first network device interface is a network interface card device of a smart network interface card type, the network device of the highest device version allowed to be connected to the second network device interface is a network interface card device of an open compute project network interface card type, the network device of the highest device version allowed to be connected to the third network device interface is a network interface card device of a peripheral component interconnect network interface card type, the device version of the network interface card device indicated by the smart network interface card type is higher than the device version of the network interface card device indicated by the open compute project network interface card type, and the device version of the network interface card device indicated by the open compute project network interface card type is higher than the device version of the network interface card device indicated by the peripheral component interconnect network interface card type.

It should be noted that the above modules may be implemented by software or hardware. For the latter, the above modules may be implemented in the following manners, but are not limited thereto: the above modules are all located in the same processor; or the above modules are respectively located in different processors in any combination forms.

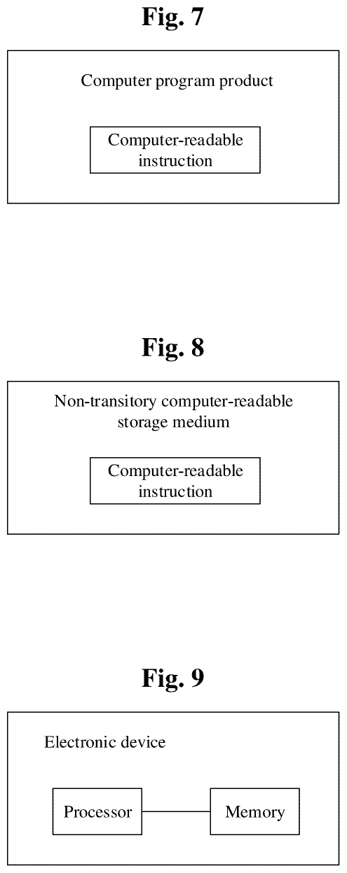

As shown in FIG. 7, an embodiment of the present disclosure further provides a computer program product, including a computer-readable instruction, wherein the computer-readable instruction implements operations of the server booting method in various embodiments of the present disclosure when executed by one or more processors; and the computer program product may further include a non-transitory computer-readable storage medium, the non-transitory computer-readable storage medium stores a computer-readable instruction, and the computer-readable instruction implements operations of the server booting method in various embodiments of the present disclosure when executed by a processor.

As shown in FIG. 8, an embodiment of the present disclosure further provides a non-transitory computer-readable storage medium, wherein a computer-readable instruction is stored in the non-transitory computer-readable storage medium, and the computer-readable instruction implements operations in any of above method embodiments when executed by one or more processors.

In some embodiments, the non-transitory computer-readable storage medium may include, but is not limited to, various media capable of storing the computer-readable instruction, such as a Universal Serial Bus (USB) flash disk, an ROM, an RAM, a removable hard disk, a magnetic disk, or an optical disk.

As shown in FIG. 9, an embodiment of the present disclosure further provides an electronic device, including one or more processors; and a memory associated with the one or more processors, wherein the memory is configured to store a computer-readable instruction, and the computer-readable instruction implements operations in any of the above method embodiments when executed by the one or more processors.

In some embodiments, the electronic device may further include a transmission device and an input/output device, wherein the transmission device is connected with the processor, and the input/output device is connected with the processor.

For examples in the present embodiment, reference may be made to the examples described in the above embodiments and exemplary implementations, and thus details are not repeated again in the present embodiment.

Obviously, it should be understood by those having ordinary skill in the art that, the modules or operations in the above present disclosure may be implemented by a general-purpose computing apparatus, may be concentrated on a single computing apparatus or distributed on a network composed of a plurality of computing apparatuses, and may also be implemented by program codes executable by the computing apparatus, therefore the modules or operations may be stored in a storage apparatus to be executed by the computing apparatus, and in some cases, the shown or described operations may be executed in a sequence different from that herein, or operations are respectively made into various integrated circuit modules, or a plurality of modules or operations therein may be made into a single integrated circuit module for implementation. In this way, the present disclosure is not limited to any particular hardware and software combination.

The above descriptions are only embodiments of the present disclosure, and are not intended to limit the present disclosure, and for those having ordinary skill in the art, the embodiments of the present disclosure may have various changes and modifications. Any modifications, equivalent replacements, improvements, and the like, made within the principles of the present disclosure, shall fall within the protection scope of the present disclosure.

1. A server booting method, wherein the server booting method is applied to a basic input output system installed in a server, a network device interface group is deployed on the server, network device interfaces in the network device interface group are used for connecting network devices, the network devices have preboot execution environment control functions, and the server booting method comprises:
in response to determining that execution has proceeded to a peripheral component interconnect enumeration stage, detecting in-place information of the network device interfaces in the network device interface group, wherein the in-place information is used for indicating whether corresponding network device interfaces are connected with the network devices;
disabling the preboot execution environment control functions of a plurality of reference network devices correspondingly connected to a plurality of reference network device interfaces in the network device interface group, wherein the reference network device interfaces are network device interfaces of which the in-place information is used for indicating that the reference network devices have been connected;
screening a target network device from the plurality of reference network devices according to reference device types of the reference network devices correspondingly connected to the plurality of reference network device interfaces, wherein the target network device is a network device of which a target booting priority corresponding to a target device type to which the network device belongs is highest among the plurality of reference network devices, device types of the network devices are used for indicating device versions of the network devices, the preboot execution environment control functions are downward compatible from high to low device versions, and each device type is set with a corresponding booting priority that is proportional to the device version indicated by the device type; and
enabling the preboot execution environment control function of the target network device.

2. The server booting method according to claim 1, wherein in response to determining that the network devices are network interface card devices, screening the target network device from the plurality of reference network devices according to the reference device types of the reference network devices correspondingly connected to the plurality of reference network device interfaces comprises:
identifying the device type of each reference network device among the plurality of reference network devices until all of the plurality of reference network devices are identified, so as to obtain a plurality of reference device types;
in response to determining that the plurality of reference device types comprise a smart network interface card type, determining a network interface card device of the smart network interface card type among the plurality of reference device types as the target network device having the highest booting priority;
in response to determining that the plurality of reference device types do not comprise the smart network interface card type, but comprise an open compute project network interface card type, determining a network interface card device of the open compute project network interface card type among the plurality of reference device types as the target network device having the highest booting priority; and
in response to determining that the plurality of reference device types do not comprise the smart network interface card type and the open compute project network interface card type, but comprise a peripheral component interconnect network interface card type, determining a network interface card device of the peripheral component interconnect network interface card type among the plurality of reference device types as the target network device having the highest booting priority.

3. The server booting method according to claim 1, wherein in response to determining that the network devices are network interface card devices, screening the target network device from the plurality of reference network devices according to the reference device types of the reference network devices correspondingly connected to the plurality of reference network device interfaces comprises:
extracting a current candidate network device to be identified from the plurality of reference network devices;
identifying the device type of the candidate network device to obtain a candidate device type, wherein the reference device types comprise the candidate device type;
determining whether the candidate device type is a smart network interface card type;
in response to determining that the candidate device type is the smart network interface card type, ending the identification in advance, and determining the candidate network device as the target network device having the highest booting priority;
in response to determining that the candidate device type is not the smart network interface card type, continuing to extract a next reference network device that has not yet been identified from the plurality of reference network devices as the current candidate network device to be identified, until there is no reference network device that has not yet been identified among the plurality of reference network devices, and ending the identification to obtain a plurality of candidate device types;
in response to determining that the plurality of candidate device types comprise an open compute project network interface card type, determining a network interface card device of the open compute project network interface card type among the plurality of reference network devices as the target network device having the highest booting priority, or
in response to determining that the plurality of candidate device types do not comprise the open compute project network interface card type, but comprise a peripheral component interconnect network interface card type, determining a network interface card device of the peripheral component interconnect network interface card type among the plurality of reference network devices as the target network device having the highest booting priority.

4. The server booting method according to claim 1, wherein disabling the preboot execution environment control functions of the reference network devices correspondingly connected to the plurality of reference network device interfaces in the network device interface group comprises:
updating network interface parameters corresponding to the plurality of reference network device interfaces to a first network interface parameter, wherein the first network interface parameter is used for instructing the corresponding reference network device interfaces to disable the preboot execution environment control functions of the reference network devices connected to the corresponding reference network device interfaces.

5. The server booting method according to claim 1, wherein enabling the preboot execution environment control function of the target network device comprises:
locating, from the plurality of reference network device interfaces, a target network device interface corresponding to the target network device; and
updating a network interface parameter of the target network device interface to a second network interface parameter, wherein the second network interface parameter is used for instructing the target network device interface to enable the preboot execution environment control function of the connected target network device.

6. The server booting method according to claim 5, wherein the server booting method further comprises: after disabling the preboot execution environment control functions of the reference network devices correspondingly connected to the plurality of reference network device interfaces in the network device interface group,
creating a control option for each reference network device interface among the plurality of reference network device interfaces on a basic input output system interface of the basic input output system, wherein each control option is used for controlling the corresponding reference network device interface to enable or disable the preboot execution environment control function of the reference network device connected to the corresponding reference network device interface.

7. The server booting method according to claim 6, wherein the server booting method further comprises: after screening the target network device from the plurality of reference network devices according to the reference device types of the reference network devices correspondingly connected to the plurality of reference network device interfaces,
detecting whether there is a control option which has been subjected to an adjustment operation; and
in response to detecting that there is the control option which has been subjected to the adjustment operation, enabling the preboot execution environment control function of the reference network device corresponding to the control option which has been subjected to the adjustment operation, and controlling other currently enabled preboot execution environment control functions in the server to be disabled.

8. The server booting method according to claim 6, wherein the server booting method further comprises: after screening the target network device from the plurality of reference network devices according to the reference device types of the reference network devices correspondingly connected to the plurality of reference network device interfaces,
detecting whether there is a control option which has been subjected to an adjustment operation;
in response to detecting that there is the control option which has been subjected to the adjustment operation, acquiring, from the plurality of reference network device interfaces, a candidate network device interface corresponding to the control option which has been subjected to the adjustment operation, and generating a target confirmation instruction, wherein the target confirmation instruction is used for requesting a target account to determine, from an alternative network device connected to the candidate network device interface and the target network device, a network device whose preboot execution environment control function is allowed to be enabled; and
receiving target confirmation information returned by the target account, and controlling the preboot execution environment control function of the corresponding network device to be enabled according to the target confirmation information, wherein the target confirmation information is used for indicating the network device whose preboot execution environment control function is allowed to be enabled.

9. The server booting method according to claim 1, wherein screening the target network device from the plurality of reference network devices according to the reference device types of the reference network devices correspondingly connected to the plurality of reference network device interfaces comprises:
detecting device types of the reference network devices correspondingly connected to the plurality of reference network device interfaces to obtain the reference device types; and
screening the target network device from the plurality of reference network devices according to the detected reference device types.

10. The server booting method according to claim 9, wherein detecting the device types of the reference network devices correspondingly connected to the plurality of reference network device interfaces to obtain the reference device types comprises:
reading device identification messages from the reference network devices correspondingly connected to the plurality of reference network device interfaces, wherein the device identification messages are used for indicating the device types of the corresponding reference network devices; and
parsing the device identification messages to obtain the reference device types of the reference network devices.

11. The server booting method according to claim 9, wherein detecting the device types of the reference network devices correspondingly connected to the plurality of reference network device interfaces to obtain the reference device types further comprises:
sending a target request instruction to the reference network devices correspondingly connected to the plurality of reference network device interfaces, wherein the target request instruction is used for requesting the reference network devices correspondingly connected to the plurality of reference network device interfaces to send device identification messages to the basic input output system, and the device identification messages are used for indicating the device types of the corresponding reference network devices; and
receiving the device identification messages sent by the reference network devices correspondingly connected to the plurality of reference network device interfaces, and parsing the device identification messages to obtain the reference device types of the reference network devices.

12. The server booting method according to claim 9, wherein detecting the device types of the reference network devices correspondingly connected to the plurality of reference network device interfaces to obtain the reference device types comprises:
sequentially detecting, according to a target detection sequence, the device types of the reference network devices correspondingly connected to the plurality of reference network device interfaces to obtain the reference device types, wherein the target detection sequence records a detection sequence of the plurality of reference network device interfaces, in the target detection sequence, the higher a rank of the reference network device interface is, the higher a reference device version of the network device allowed to be connected to the reference network device interface is, and the reference device version is the highest device version of the network device allowed to be connected to the corresponding reference network device interface.

13. The server booting method according to claim 12, wherein the server booting method further comprises: in response to determining that the network devices are network interface card devices, before sequentially detecting, according to the target detection sequence, the device types of the reference network devices correspondingly connected to the plurality of reference network device interfaces to obtain the reference device types,
in response to determining that the plurality of reference network device interfaces comprise a first network device interface, a second network device interface and a third network device interface, constructing a first detection sequence in an order of the first network device interface, the second network device interface and the third network device interface, wherein the target detection sequence comprises the first detection sequence;
in response to determining that the plurality of reference network device interfaces comprise the first network device interface and the third network device interface, constructing a second detection sequence in an order of the first network device interface and the third network device interface, wherein the target detection sequence comprises the second detection sequence; or
in response to determining that the plurality of reference network device interfaces comprise the second network device interface and the third network device interface, constructing a third detection sequence in an order of the second network device interface and the third network device interface, wherein the target detection sequence comprises the third detection sequence, wherein
the network device of the highest device version allowed to be connected to the first network device interface is a network interface card device of a smart network interface card type, the network device of the highest device version allowed to be connected to the second network device interface is a network interface card device of an open compute project network interface card type, the network device of the highest device version allowed to be connected to the third network device interface is a network interface card device of a peripheral component interconnect network interface card type, the device version of the network interface card device indicated by the smart network interface card type is higher than the device version of the network interface card device indicated by the open compute project network interface card type, and the device version of the network interface card device indicated by the open compute project network interface card type is higher than the device version of the network interface card device indicated by the peripheral component interconnect network interface card type.

14. The server booting method according to claim 4, wherein updating the network interface parameters corresponding to the plurality of reference network device interfaces to the first network interface parameter comprises:
sending, by the basic input output system, a first update instruction carrying the first network interface parameter to the plurality of reference network device interfaces; and
in response to the first update instruction, updating the network interface parameters corresponding to the plurality of reference network device interfaces to the first network interface parameter.

15. The server booting method according to claim 10, wherein reading the device identification messages from the reference network devices correspondingly connected to the plurality of reference network device interfaces comprises:
reading, by the basic input output system, the device identification messages from the reference network devices correspondingly connected to the plurality of reference network device interfaces.

16. The server booting method according to claim 1, wherein in response to determining that the network devices are network interface card devices, screening the target network device from the plurality of reference network devices according to the reference device types of the reference network devices correspondingly connected to the plurality of reference network device interfaces comprises:
identifying the reference device types of the plurality of reference network devices to obtain all reference device types, and determining the target network device from all the reference device types.

17. (canceled)

18. A computer program product, wherein the computer program product stores a computer-readable instruction, and the computer-readable instruction implements operations of the server booting method according to claim 1 when executed by one or more processors.

19. A non-transitory computer-readable storage medium, wherein the non-transitory computer-readable storage medium stores a computer-readable instruction, and the computer-readable instruction implements operations of the server booting method according to claim 1 when executed by one or more processors.

20. An electronic device, comprising:
one or more processors; and
a memory associated with the one or more processors, wherein the memory is configured to store a computer-readable instruction, and the computer-readable instruction implements operations of the server booting method according to claim 1 when executed by the one or more processors.

21. The server booting method according to claim 2, wherein
in response to determining that there are a plurality of smart network interface cards, the first identified smart network interface card is determined as the target network device, or one smart network interface card is randomly selected from the plurality of smart network interface cards as the target network device; or,
in response to determining that there are a plurality of open compute project network interface cards, the first identified open compute project network interface card is determined as the target network device, or, one open compute project network interface card is randomly selected from the plurality of open compute project network interface cards as the target network device; or,
in response to determining that there are a plurality of peripheral component interconnect network interface cards, the first identified peripheral component interconnect network interface card is determined as the target network device, or one peripheral component interconnect network interface card is randomly selected from the plurality of peripheral component interconnect network interface cards as the target network device.
